(19) United States
(12) Patent Application Publication
(10) Pub. No.: US 2006/0108264 A1
(43) Pub. Date: May 25, 2006

(54) Screening support frame

(76) Inventors: Kevin James Moore, Lexington, KY (US); Gregory T. Joseph, Hurricane, WV (US)

Correspondence Address: FROST BROWN TODD, LLC, 2200 PNC CENTER, 201 E. FIFTH STREET, CINCINNATI, OH, 45202, US

(21) Appl. No.: 11/046,928

(22) Filed: Jan. 31, 2005

Related U.S. Application Data
(60) Provisional application No. 60/540,500, filed on Jan. 30, 2004.

(51) Int. Cl. B07B 1/49

(52) U.S. Cl. 209/395; 209/405

(57) ABSTRACT

A screening support frame for use with modular screening systems. The frame comprises an attachment bar and a plurality of housings. Each attachment bar comprises one or more notches. Each housing is adapted to be lockingly received by a notch of an attachment bar. Also, each housing is adapted to releasably receive one or more legs from one or more screen panels.

This application claims the benefit of U.S. Provisional Patent Application entitled “Narrow Synthetic Screen Support Member With Replaceable Engagement Hold”, U.S. Application Ser. No. 60/540,500, filed on Jan. 30, 2004.

### TECHNICAL FIELD

This application relates generally to modular screening systems and more particularly to a support frame for use in such systems.

### BACKGROUND OF THE INVENTION

Modular screening systems are typically used in mining or mineral processing operations for separating aggregates by particle size. Typical modular screening systems include attachment bars secured to a support structure. Each attachment bar typically includes a number of holes for receiving legs of screen panels or modules. Normally, legs from two or more adjacent screen panels are disposed within a hole of an attachment bar and a pin is driven between the legs causing the legs to flare, thereby securing the panels in place.

During screening operations, small particles tend to accumulate in the open areas surrounding the union of the legs of the screen panels, the corresponding holes of the attachment bars and the pins. Over time, these particles may wear away legs, pins and the holes such that panels are no longer tightly secured. Eventually, each of the worn components will need to be replaced. While most modular systems are designed such that replacement of worn screen panels and pins may be accomplished relatively quickly and inexpensively, replacing the attachment bar can be time consuming and costly as the worn attachment bars will need to be removed from the support structure and new attachment bars fabricated and subsequently secured to the support structure.

In addition, the conventional attachment bars tend to be relatively wide in order to include holes large enough to accommodate the legs of the screen panels. The widths of these attachment bars create dead areas between adjacent screen panels limiting the screening system's efficiency.

The present invention pertains to a modular screening system where attachment bar wear is greatly minimized through the use of a housing inserted between the attachment bar and the legs of screen panels. In addition, the present invention pertains to a modular screening system with a narrower attachment bar which provides less dead area between adjacent screen panels.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 depicts a side view of an attachment bar according to the present invention;

FIG. 2 depicts a top view of a housing of the present invention;

FIG. 3 depicts a front view of a housing of the present invention;

FIG. 4 depicts a side view of a housing of the present invention;

FIG. 5 depicts a cross-sectional view taken along line 5-5 of FIG. 2;

FIG. 6 depicts an isometric exploded view of a modular screening system of the present invention;

FIG. 7 depicts an isometric exploded view of a modular screening system of the present invention;

FIG. 8 depicts a cross-sectional view taken along line 8-8 of FIG. 7; and

FIG. 9 depicts a cross-sectional view taken along line 9-9 of FIG. 8.

### DETAILED DESCRIPTION OF THE INVENTION

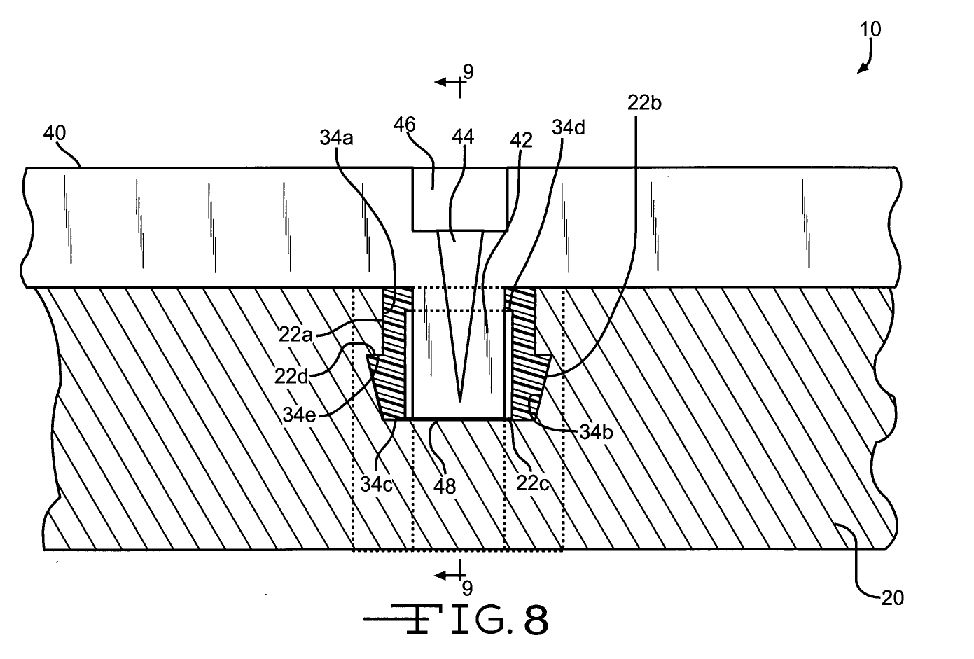

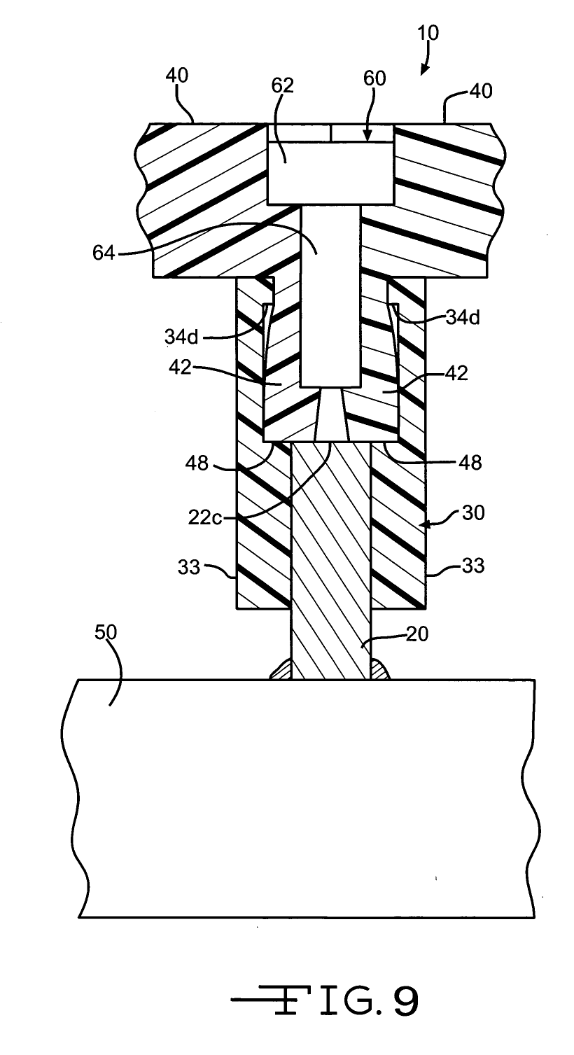

Referring now to the figures wherein like numerals indicate like elements throughout. A modular screening system 10 incorporating the principles of the present invention is shown in FIGS. 6 through 9. An attachment bar 20 is secured to a support structure 50. Each attachment bar 20 includes one or more notches 22 adapted to lockingly receive a housing 30. Each housing 30 may include an aperture 32 for releasably receiving one or more legs 42 from one or more screen panels 42.

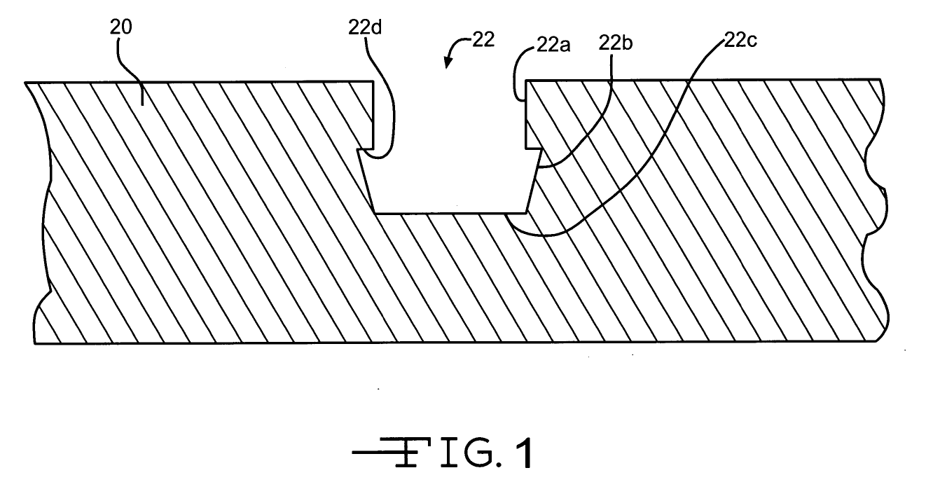

FIG. 1 shows an exemplary embodiment of the attachment bar 20. The attachment bar is secured to a support structure 50 by welds, fasteners, adhesives or the like. The bar 20 may be an elongated rectangular steel bar. However, the bar may be comprised of any suitably durable material, including but not limited to aluminum, high strength polymers and the like. The bar 20 is preferably between about 2 inches to about 5 inches in height and between about 0.5 inches to about 0.75 inches in width. However, it should be appreciated that the bar 20 may be of any size or shape which would provide sufficient support to screen panels 40.

The attachment bar 20 includes a plurality of notches 22. The notches 22 are preferably placed on regular centers as shown in FIG. 6. Each notch 22 may include an upper region 22a, a lower region 22b and a bottom 22c. The width of the upper region 22a is preferably less than the width of the lower region 22b. Additionally, the upper region 22a and lower region 22b may be separated by a lip 22d. Also, as shown in FIG. 1, the lower region 22b may be widest near the lip 22d and may taper towards the bottom 22c. The upper region 22a is preferably between about 1 inch and about 2 inches in width. The lower region 22b is preferably between about 1.25 inches and about 2.25 inches in width. The bottom 22c may be between about 1 inch and about 2.25 inches in width. The notch 22 is preferably between about 1 inch to about 1.5 inches in height with the upper region 22a and lower region 22b each having a height of about half the overall height of the notch 22. Alternative notch sizes and shapes will be readily apparent to one skilled in the art.

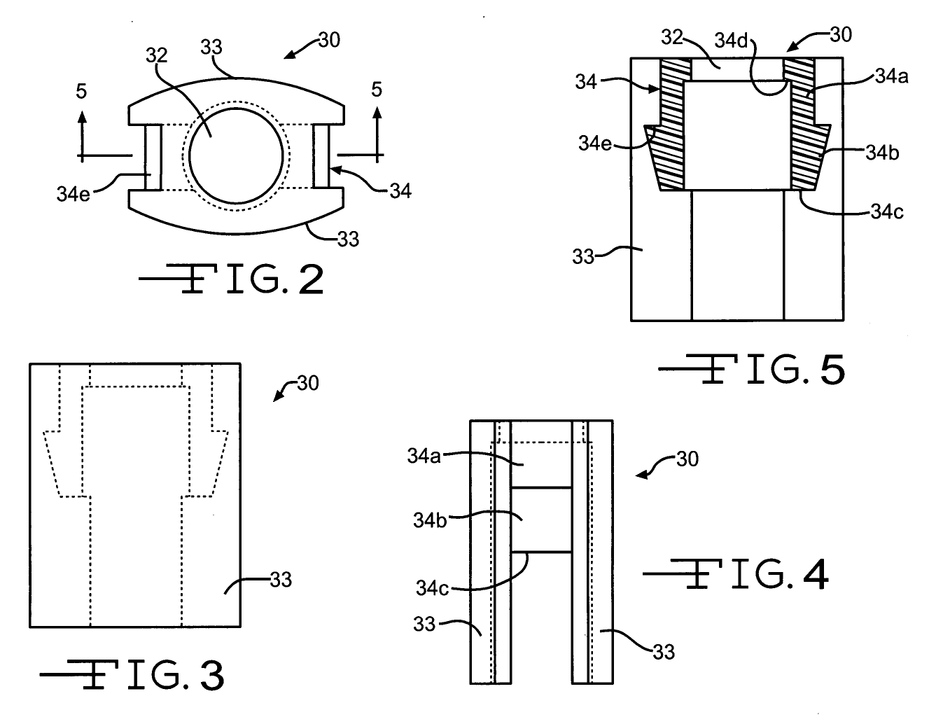

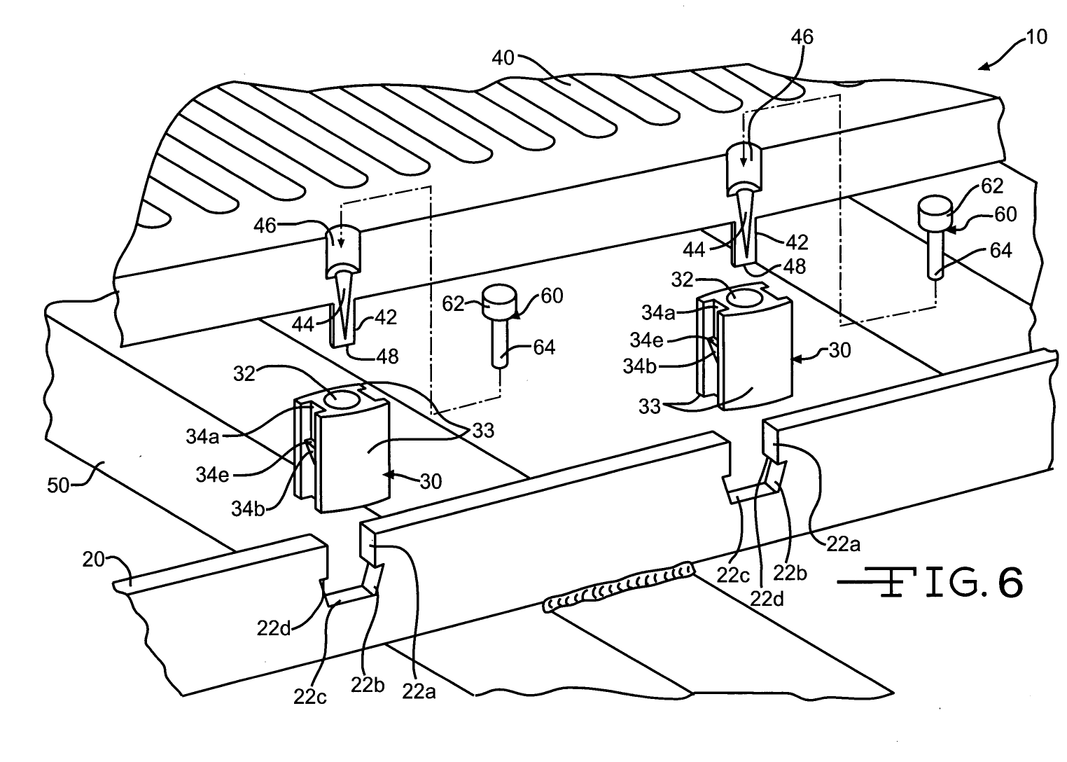

Referring now to FIGS. 2 through 5 where an exemplary embodiment of a housing 30 is shown. The housing 30 is designed to be lockingly engaged by a notch 22 of an attachment bar 20 and to receive one or more legs 42 of screen panels 40 (discussed below). The housing 30 may include two side portions 33 separated by an intermediate portion 34.

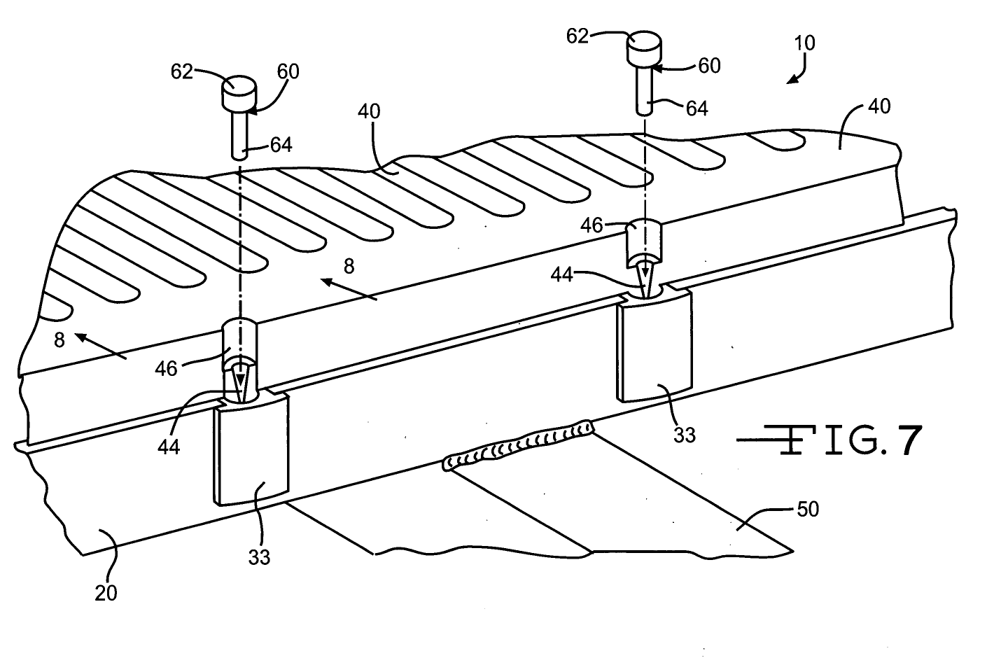

As shown in FIG. 5, the intermediate portion 34 preferably has a cross-section substantially complimentary in size and shape and to the notch 22 of the attachment bar 20 such that engagement of the intermediate portion 34 and notch 22 lockingly secures the housing 30 to the attachment bar 20 with substantially no open space between the intermediate portion 34 and the notch 22. For example, as related to the notch 22 shown in FIG. 1, the intermediate portion 34 may have a base 34c, an upper segment 34a and a lower segment 34b, where the width of the upper segment 34a may be less than the width of the lower segment 34b. The upper segment 34a and lower segment 34b may be separated by a rim 34e. Also, the lower segment 34b may be widest near the rim 34e and may taper towards the base 34c. The upper segment 34a is preferably between about 1 inch and about 2 inches in width. The lower segment 34b is preferably between about 1.25 inches and about 2.25 inches in width. The base 34c may be may be between about 1 inch and about 2.25 inches in width. The intermediate portion 34 is preferably between 1 inch to 1.5 inches in height with the upper segment 34a and lower segment 34b each having a height of about half the overall height of the intermediate portion 34.

The housing 30 may also include an aperture 32 that preferably extends vertically through the intermediate portion 34. The upper segment 34a may include an annular ridge 34d about the aperture 32 and preferably near the upper surface of the housing 30. The diameter of the aperture 32 is preferably about the same diameter of adjacent legs 42 of adjacent screen panels 40. Additionally, the diameter of the aperture 32 is preferably larger than the width of the attachment bar 20 to allow trapped particles to escape past the attachment bar 20. For example, the diameter of the aperture 32 may be between about 1 inch to about 1.25 inches. The diameter of the annular ridge 34d is preferably slightly larger than the diameter of the aperture 32 as shown in FIGS. 2 through 5; for example, the diameter of the annular ridge 34d may be about 5/32 inch larger than the diameter of the aperture 32.

The overall height of the housing 30 may be between about 2 inches to about 3 inches, the overall width may be between about 1 inch to about 2 inches and the overall breadth may be between about 1 inch to about 2 inches. However, it should be appreciated that the housing 30 may be of any size or shape which would lockingly engage a notch 22 of an attachment bar 20 as well as releasably receive one or more legs 42 of one or more screen panels 40.

The housing 30 is preferably comprised of a durable, deformable and resilient material such as molded urethane, UHMW, rubber and the like. The housing 30 may be molded as one piece where the aperture 32 and annular ridge 34d are included in the initial molding process or added in a subsequent operation, such as drilling and the like. Alternatively, the housing 30 may be comprised of two halves, which may be secured together with bolts, adhesive, ultra-sonic welding, and the like.

In another embodiment, the housing 30 may be comprised of halves, where one half includes the intermediate portion 34, the aperture 32 and ridge 34d. One half may have a male protrusion, which may extend below or through the attachment bar 20 to a corresponding female receptor of the opposite half.

Referring now to FIGS. 6 through 9, a modular screening system 10 employing the principles of the present invention is shown. A typical screen panel 40 comprises one or more legs 42 spaced about the panel's lower perimeter and more typically at the corners of the panel. Each leg 42 may have a receptacle 44 for receiving a shaft 64 of a locking pin 60. The receptacle 44 may have a width slightly smaller than the diameter of the shaft 64 of a locking pin 60 such that upon disposal of a locking pin 60 within the receptacles 44 of adjacent legs 42 of adjacent panels 40 the legs 42 of each panel 40 flare. Alternatively and as shown in the figures, to simplify locking pin 60 insertion, each receptacle 44 may have a half-cone shape with the apex nearest to the foot 48 of the leg 42 such that adjacent legs 42 of adjacent panels 40 provide a cone shape receptacle therebetween where further disposition of the shaft 64 of a locking pin 60 into the receptacles 44 causes further flaring of each leg 42. Also, the distal end of the shaft 64 of the pin 60 may be chamfered to facilitate disposing the shaft 64 of the pin 60 within the receptacle 44.

The screen panel 40 may include recesses 46 above each receptacle 44 to accommodate the head 62 of a pin 60. The head 62 of the pin 60 may have various features or shapes to assist in inserting and/or removing the pin 60 from the receptacle 44 of the screen panels 40. The recess 46 and/or head 62 of the locking pin 60 may be dimensioned where, upon disposition of the shaft 64 within the receptacles 44, the head 62 of the locking pin 60 sits fully within the recess 46, flush with the upper surface of the screen panel 40 or slightly protruding above the upper surface of the screen panel 40. While the aforementioned screen panel 40 and locking pin 60 have been described in considerable detail, it is understood that the attachment bar 20 and housing 30 may work as equally well with a wide variety of screen panels and pins. The description herein of the screen panel 40 and pin 60 should be understood as illustrative and not limiting in any way.

In use, the intermediate portion 34 of a housing 30 is inserted into a notch 22 of an attachment bars 20 until the intermediate portion 34 is lockingly engaged within the notch 22 where the upper segment 34a of the intermediate portion 34 is positioned within the upper region 22a of the notch 22, the lower segment 34b of the intermediate portion 34 is positioned within the lower region 22b of the notch 22, and the rim 34e of the intermediate portion 34 is engaged with the lip 22d of the notch 22. Also, the intermediate portion 34 of the housing 30 and the notch 22 may be sized such that full insertion of the intermediate portion 34 within the notch 22 includes the bottom 22c of the notch 22 providing vertical support to the housing 30 through the base 34c of the intermediate portion 34. Further, the intermediate portion 34 of the housing 30 and the notch 22 may be sized such that full insertion of the intermediate portion 34 within the notch 22 allows the top surface of the housing 30 to be substantially flush with the top surface of the attachment bar 20.

The aperture 32 of a housing 30 then receives legs 42 of adjacent screen panels 40. In the illustrative embodiment of FIGS. 6 through 9, each aperture 32 receives two legs 42, each leg 42 from an adjacent screen panel 40; however, it is understood that the aperture 32 may receive only one leg 42 or may receive more than two legs 42. Preferably, once the legs 42 are fully received, the screen panel 40 sits flush atop the attachment bar 20 and the foot 48 of each leg 42 sits flush atop the bottom 22c of the notch 22. As best shown in FIG. 9, a locking pin 60 may then be driven into the receptacles 44 of adjacent screen panels 40 flaring each leg 42 beneath the ridge 34d of the intermediate portion 34 of the housing 30 thereby securing the screen panel 40 in position.

Given the locking relationship between the attachment bars 20 and housings 30, in most instances, only the housings 30, instead of entire attachment bars 20, will need to be replaced due to wear over time from particles accumulating in and working through the small areas between the legs 42 of the screen panels 40, the locking pins 60 and housings 30. In addition, the relatively narrow width of the attachment bar 20 allows for less dead area between adjacent screen panels 40.

While the present invention has been illustrated by the description of several embodiments and while the illustrative embodiments have been described in considerable detail, it is not the intention of the applicant to restrict or in any way limit the scope of the appended claims to such detail. Additional advantages and modifications may readily appear to those skilled in the art.

What is claimed is:

1. A screening support frame for a modular screening system comprising:
a plurality of attachment bars, each bar having at least one notch; and
a plurality of housings, each housing comprising first and second side portions and an intermediate portion between the first and second side portions, wherein the intermediate portion is adapted to be lockingly engaged by a notch of an attachment bar, each housing further comprising an aperture adapted to receive at least one leg of at least one screen panel.

2. The support frame of claim 1 wherein the notch of each attachment bar comprises an upper region and a lower region.

3. The support frame of claim 2 wherein the width of the upper region of the notch is less than the width of the lower region.

4. The support frame of claim 3 wherein the intermediate portion of each housing further comprises an upper segment and a lower segment.

5. The support frame of claim 4 wherein the upper segment of the intermediate portion of each housing has a width less than the width of the lower segment.

6. The support frame of claim 5 wherein the width of the upper region of the notch and the width of the upper segment of the intermediate portion of the housing are substantially equal.

7. The support frame of claim 5 wherein the width of the lower region of the notch and the width of the lower segment of the intermediate portion of the housing are substantially equal.

8. The support frame of claim 5 wherein the upper region of the notch engages the upper segment of the intermediate portion of the housing and wherein the lower region of the notch engages the lower segment of the intermediate portion of the housing.

9. The support frame of claim 5 wherein each notch further comprises a lip between the upper region and the lower region.

10. The support frame of claim 9 wherein the intermediate portion of each housing further comprises a rim between the upper segment and the lower segment, wherein the upper region of the notch engages the upper segment of the intermediate portion of the housing, the lower region of the notch engages the lower segment of the intermediate portion of the housing and the lip of the notch lockingly engages the rim of the intermediate portion of the housing.

11. A modular screening system comprising:
a plurality of screens, each screen having a plurality of legs;
a plurality of attachment bars, each bar having at lease one notch; and
a plurality of housings, each housing comprising first and second side portions and an intermediate portion between the first and second side portions, wherein the intermediate portion is adapted to be lockingly engaged by a notch of an attachment bar, each housing further comprising a aperture adapted to releaseably receive a plurality of legs of a plurality of screens.

12. The screening system of claim 11 wherein the notch of each attachment bar comprises an upper region and a lower region, wherein the width of the upper region is less than the width of the lower region.

13. The screening system of claim 12 wherein the intermediate portion of each housing further comprises an upper segment and a lower segment, wherein the upper segment has a width less than the width of the lower segment.

14. The screening system of claim 13 wherein each notch further comprises a lip between the upper region and the lower region.

15. The screening system of claim 14 wherein the intermediate portion of each housing further comprises a rim between the upper segment and the lower segment, wherein the upper region of the notch engages the upper segment of the intermediate portion of the housing, the lower region of the notch engages the lower segment of the intermediate portion of the housing and the lip of the notch lockingly engages the rim of the intermediate portion of the housing.

16. The screening system of claim 13 wherein the aperture of the housing extends through the intermediate portion of the housing.

17. The screening system of claim 16 further comprising a locking pin, and wherein the intermediate portion further comprises an annular ridge between the upper segment and the aperture wherein the locking pin is driven between the plurality of legs of the screens members disposed within the aperture of the housing wherein each leg releasably engages the annular ridge.
